(19) United States
(12) Patent Application Publication
(10) Pub. No.: US 2015/0290778 A1
(43) Pub. Date: Oct. 15, 2015

(54) Expanding Grips

(71) Applicant: Todd Joseph Burns, Albuquerque, NM (US)

(72) Inventor: Todd Joseph Burns, Albuquerque, NM (US)

(21) Appl. No.: 14/709,022

(22) Filed: May 11, 2015

Related U.S. Application Data
(60) Provisional application No. 61/944,104, filed on Feb. 25, 2014.

(51) Int. Cl. B25B 7/04

(52) U.S. Cl. CPC B25B 7/04

(57) ABSTRACT

A multifunctional tool having an interchangeable head is provided. The tool includes a pair of arms each having a jaw displacement end. A female pivot member having a central aperture is interdisposed between the jaw displacement ends and pivotally connects to each arm. At least two nodes are disposed on the front face and rear face of the jaw displacement end. An interchangeable head having a plurality of apertures and a male pivot member mates with the nodes of the female pivot member disposed on the jaw displacement end. A locking pin extends through the central apertures of the pivot members to attach the interchangeable head to the jaw displacement ends. When the interchangeable head is attached to the nodes on the front face, the tool functions as a clamp. When the interchangeable tool is attached to the nodes on the rear face, the tool functions as a separating apparatus.

### FIELD OF THE INVENTION

The present invention generally relates to a clamping and separating apparatus. More particularly, the present invention relates to a device having interchangeable heads on the jaws of the device, the device including a pair of arms having opposing top and bottom ends, the top end of each of the handles is connected at a pivot point. Each arm has a pair of nodes on each face to receive an interchangeable head thereby providing a clamping or separating function.

### BACKGROUND OF THE INVENTION

A hand tool in the form of a pair of pliers has long been known. A conventional form of a pair of pliers comprises a pair of handles mounted in a scissors arrangement. One end of the handles is adapted to connect with a user's hand. The opposite end of the handles includes an operating head. Generally, the operating head includes a pair of jaws. Squeezing together of the handles results in the jaws being closed. An object that is to be gripped is to be located between the jaws, and when the jaws are closed, the object is gripped.

Pliers come in numerous different configurations. The most common configuration of pliers is what is called a slip joint pliers where the jaw elements of the pliers are blunted. Also, another type of blunted jaw pliers, commonly referred to as a lineman's pliers, which includes a wire cutter. There are many additional configuration of pliers where the jaws of the pliers may be flattened, may be arcuate or may include a special configuration for gripping onto a particular type of structure such as diagonal cutting plier, combination plier, wire stripper, fencing plier, pincer, carpenter plier, water pump plier, flat nose plier, hose clamp plier and end nipper.

Due to the multitude of configurations of pliers, consumers must typically purchase multiple pliers for different jobs. This can result in substantial expense just for pliers. Therefore, there is a need for a tool with interchangeable heads with improved interchangeability designs and safety features that has multiple functions. In addition, the improved tool should provide various head functions and designs such as different heads for separating and clamping.

### SUMMARY OF THE INVENTION

In view of the foregoing disadvantages inherent in the known types of plier type devices with interchangeable heads now present in the prior art, the present invention provides a new and improved multifunctional tool having an interchangeable head wherein the same can be utilized for providing convenience for the user when clamping, snipping, or separating an object.

It is therefore an object of the present invention to provide a new and improved multifunctional tool having an interchangeable head for separating, clamping, or snipping that has all of the advantages of the prior art and none of the disadvantages.

It is an object of the present invention to provide a multifunctional tool having an interchangeable head including a pair of arms comprising a jaw displacement end including an upper portion and a lower portion. The jaw displacement end has a front face and a rear face including at least two nodes on each face of the jaw displacement end.

It is another object of the present invention to provide a multifunctional tool having an interchangeable head having a female pivot member interdisposed between the jaw displacement ends that pivotally connects each arm. The female pivot member includes a central aperture therethrough.

It is yet another object of the present invention to provide a multifunctional tool having an interchangeable head including a spring interdisposed between the jaw displacement ends of each arm. The spring is coupled to the jaw displacement end of each arm.

It is a further object of the present invention to provide a multifunctional tool having an interchangeable head, wherein the interchangeable head has a plurality of apertures configured to receive the nodes disposed on the jaw displacement end. The interchangeable head comprises a connection end and a tool end. The connection end includes a male pivot member having a central aperture therethrough. The male pivot member includes grooves that mate with the female pivot member.

A further object of the present invention is to provide a multifunctional tool having an interchangeable head including a locking pin that extends through the central apertures of the first and second pivot members. The locking pin includes a hinged flange member configured to lock the locking pin between the first and second central pivot members.

It is a further object of the present invention to provide an apparatus wherein each jaw displacement end is coupled to a spring commonly shared between the jaw displacement ends.

Yet another object of the present invention is to provide a multifunctional tool having an interchangeable head wherein the tool provides at least two functions for the interchangeable head depending on which face the interchangeable tool is coupled to. When the interchangeable tool is attached to the nodes on the front face, the tool functions as a clamp. When the interchangeable tool is attached to the nodes on the rear face, the tool functions as a separating apparatus.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the front face of the multi-functional tool according to one embodiment of the present invention.

FIG. 2 shows a perspective view of the rear face of the multi-functional tool according to one embodiment of the present invention.

FIG. 3 shows a perspective view of the multi-functional tool according to one embodiment of the present invention.

FIG. 4 shows a side perspective view of the multi-functional tool according to one embodiment of the present invention.

FIG. 5 shows the interchangeable tool head of the multi-functional tool according to one embodiment of the present invention.

FIG. 6 shows the locking pin of the multi-functional tool according to one embodiment of the present invention.

### DETAILED DESCRIPTION OF THE INVENTION

Reference is made herein to the attached drawings. Like reference numerals are used throughout the drawings to depict like or similar elements of the multi-functional tool with interchangeable heads. For the purposes of presenting a brief and clear description of the present invention, the preferred embodiment will be discussed as used for separating, clamping, snipping and the like. The figures are intended for representative purposes only and should not be considered to be limiting in any respect.

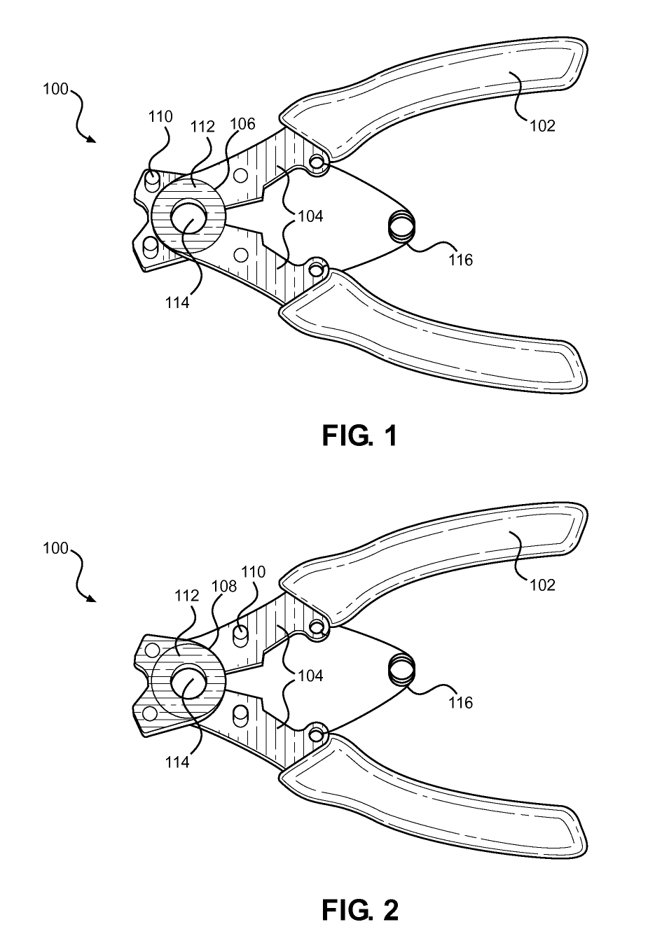

Referring now to FIGS. 1 and 2, there are shown perspective views of the front face and rear face of the multi-functional tool, respectively. The multifunctional tool 100 comprises a pair of arms 102, wherein each arm 102 includes a jaw displacement end 104. The arms 102 are pivotally connected to each other via a female pivot member 112. The female pivot member 112 is interdisposed between the jaw displacement ends 104 of the arms 102. The female pivot member 112 includes grooves on the front face and the rear face to receive a mating member. A central aperture 114 extends through a central region of the female pivot member 112.

Each of the arms 102 comprise a jaw displacement end 104 having a front face 106 and a rear face 108. The jaw displacement ends 104 extend from the handle portion to the distal end of the tool 100. Each face 106, 108 includes at least two nodes 110 disposed thereon. The nodes 110 are hemispherical protrusions that extend from each face of the jaw displacement ends 102. At least two nodes 110 are located on each face of the jaw displacement ends 102. As illustrated, on the front face 106 of the jaw displacement end 104, two nodes 110 are located above the female pivot member 112 at distal ends of the upper portions of the jaw. The nodes 110 on the upper portion of the jaws are adjacent to each other. On the rear face 108 of the jaw displacement end 104, two nodes 110 are located below the female pivot member 112. The nodes 110 that are disposed on the lower portion of the jaw displacement end 104 are separated by a space.

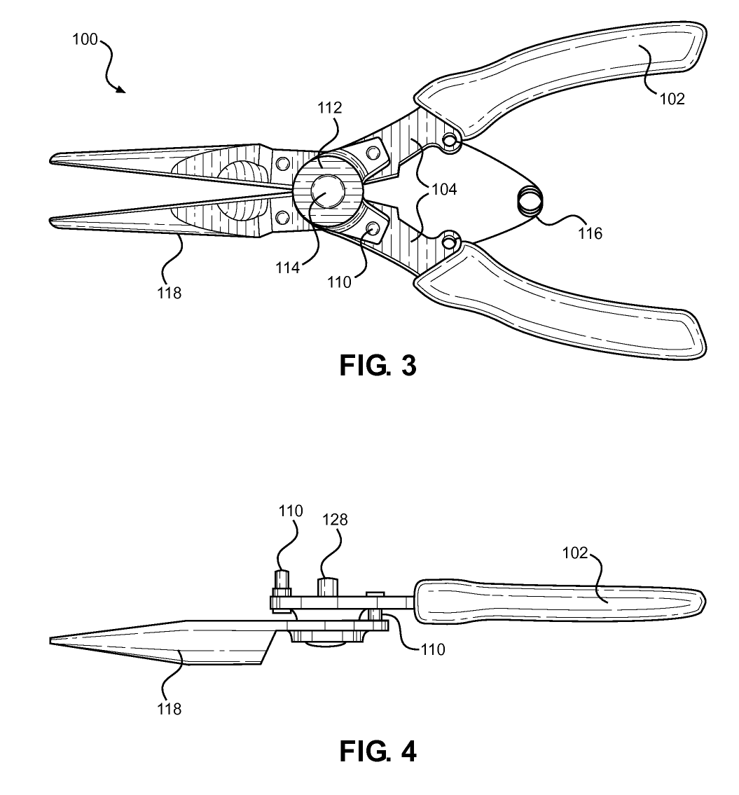

Referring now to FIGS. 3 and 4, there are shown perspective views of the multi-functional tool according to embodiments of the invention. The multi-functional tool 100 is adapted to provide a clamping or separating function depending on which face the interchangeable tool head 118 is removably attached to. When the interchangeable tool 118 is attached to the nodes 110 on the front face, the tool 100 functions as a clamp. When the interchangeable tool head 118 is attached to the nodes 110 on the rear face, the tool 100 functions as a separating apparatus.

The nodes 110 on the rear face are adjacent to one another and provides the tool head 118 in a closed configuration via a spring 116. The spring 116 is interdisposed between the jaw displacement ends 104 of each arm 102. The spring 116 is coupled to the jaw displacement end 104 of each arm 102 and biases the interchangeable tool head 118 to a closed position. When an inward force is applied to the handles, the prongs of the interchangeable tool head 118 separate in relation to one another. The interchangeable tool head 118 may be locked in this closed position via a locking mechanism at the bottom end of the handle portion. In another embodiment of the present invention, the arms 102 further comprise a locking mechanism. The locking mechanism is a series of interlocking grooved teeth on each arm 203 adapted to adjust a force applied by the interchangeable tool.

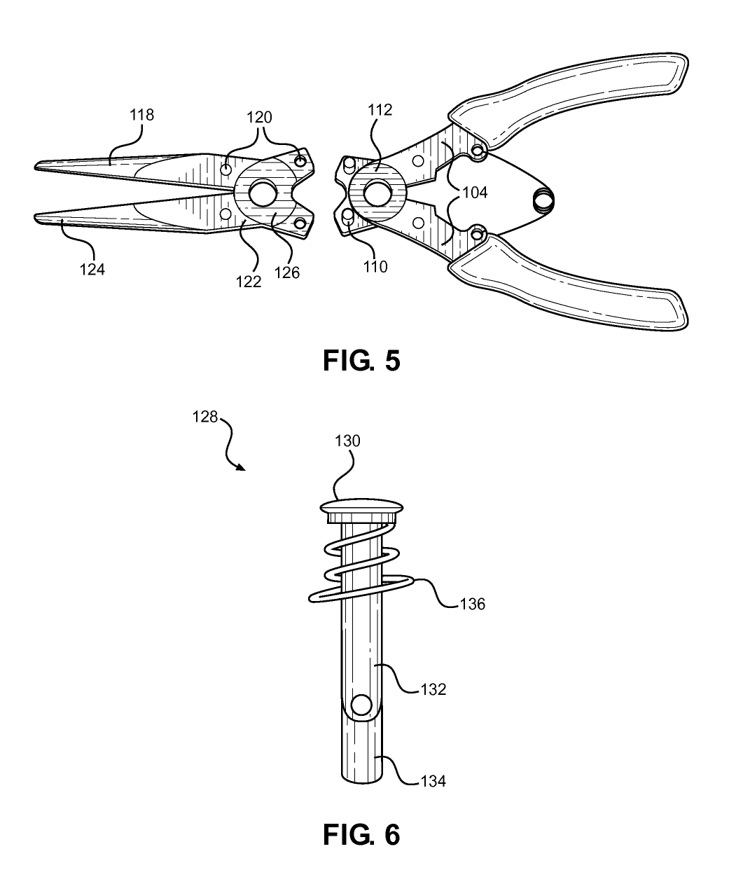

Referring now to FIG. 5, there is shown the interchangeable tool head of the apparatus according to one embodiment of the present invention. The interchangeable head 118 includes a plurality of apertures 120 configured to receive the nodes 110 disposed on the jaw displacement ends 104. Furthermore, the interchangeable head 118 also includes a connection end 122 and a tool end 124. The connection end 122 includes a male pivot member 126 having a central aperture therethrough. A locking pin 128 extending through the central apertures of the female and male pivot members 112, 126.

The interchangeable head 118 includes at least two upper apertures 120 located above the male pivot member 126 and at least two lower apertures 120 located below of the male pivot member 126. The upper apertures 120 are adapted to engage with the nodes 110 on the upper end of the jaw displacement ends 104. The lower apertures 120 are adapted to engage with the nodes 110 on the lower end of the jaw displacement ends 104. In one embodiment, the nodes 110 on the front face of the jaw displacement end 104 are configured to expand the interchangeable tool head 118 when the arms are compressed and the nodes 110 on the rear face of the jaw displacement end 104 are configured to clamp the interchangeable tool head 118 when the arms are compressed. In the illustrated embodiment, the interchangeable tool 118 comprises a pair of prongs with grooves on each side of the prongs for clamping and separating.

Referring now to FIG. 6, there is shown the locking pin according to one embodiment of the present invention. The locking pin 128 extends through the central apertures of the female and male pivot members. The male pivot member engages with the female pivot member and the locking pin 128 is placed therethrough. The locking pin 128 includes a flat head 130 and a receiving end 132. The receiving end 132 includes an aperture to receive a hinged flange member 134 that is movable within the aperture at the receiving end 132. The hinged flange member 134 has an orthogonal position relative to the locking pin 128, wherein the hinged flange member 134 locks the locking pin 128 within the central apertures of the male and female central pivot members. The hinged flange member 134 has a parallel position within the receiving end when removing the locking pin 128 from the pivot members. A spring 136 is disposed on the locking pin 128 to secure the pin through the pivot members.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A multifunctional tool having an interchangeable head, comprising:
a pair of arms each comprising a jaw displacement end having a front face and a rear face;
wherein said front face and said rear face each include at least two nodes on each face;
a female pivot member interdisposed between the jaw displacement ends pivotally connecting each arm, wherein the female pivot member includes a central aperture therethrough;
a spring interdisposed between the jaw displacement ends of each arm, wherein the spring is coupled to the jaw displacement end of each arm;
an interchangeable head having a plurality of apertures configured to receive the nodes disposed on each jaw displacement end, the interchangeable head comprising a connection end and a tool end, wherein the connection end includes a male pivot member having a central aperture therethrough;
a locking pin extending through the central apertures of the female and male pivot members.

2. The multifunctional tool of claim 1, wherein the at least two nodes are disposed on an upper portion of the jaw displacement end, wherein the nodes are adjacent to each other.

3. The multifunctional tool of claim 2, wherein the nodes are disposed on the front face of each jaw displacement end.

4. The multifunctional tool of claim 1, wherein the at least two nodes are disposed on a lower portion of the jaw displacement end, wherein the nodes are separated by a space.

5. The multifunctional tool of claim 4, wherein the nodes are disposed on the rear face of the jaw displacement end.

6. The multifunctional tool of claim 1, wherein the interchangeable head includes at least two upper apertures and at least two lower apertures.

7. The multifunctional tool of claim 1, wherein the locking pin further includes a flat head and a receiving end, wherein the receiving end includes an aperture to receive the hinged flange member.

8. The multifunctional tool of claim 7, wherein the hinged flange member has a parallel position within the receiving end.

9. The multifunctional tool of claim 7, wherein the hinged flange member is orthogonal relative to the locking pin, wherein the hinged flange member locks the locking pin within the central apertures of the male and femal pivot members.

10. The multifunctional tool of claim 1, the arms further comprise a locking mechanism.

11. The multifunctional tool of claim 10, wherein the locking mechanism is a series of interlocking grooved teeth on each arm adapted to adjust a force applied by the interchangeable tool.

12. The multifunctional tool of claim 1, wherein the tool end of the interchangeable head is a needle nose plier having grooved surfaces on each side of the needle nose.

13. The multifunctional tool of claim 1, wherein the nodes on the front face of the jaw displacement end are configured to expand the interchangeable head when the arms are compressed.

14. The multifunctional tool of claim 1, wherein the nodes on the rear face of the jaw displacement end are configured to clamp the interchangeable head when the arms are compressed.
